(19) United States
(12) Patent Application Publication
(10) Pub. No.: US 2016/0033950 A1
(43) Pub. Date: Feb. 4, 2016

(54) CONTROL STATION UTILIZING USER'S STATE INFORMATION PROVIDED BY MOBILE DEVICE AND CONTROL SYSTEM INCLUDING THE SAME

(71) Applicant: Yoo Chol JI, Seoul (KR)

(72) Inventor: Yoo Chol JI, Seoul (KR)

(21) Appl. No.: 14/791,480

(22) Filed: Jul. 6, 2015

(30) Foreign Application Priority Data
Jul. 4, 2014 (KR) 10-2014-0083964

(51) Int. Cl. G05B 15/02

(52) U.S. Cl. CPC G05B 15/02

(57) ABSTRACT

A control station which controls adjacent devices connected with the control station on wire or wirelessly. The control station gives an on/off command as well as an option required to execute the command. The control station communicates with a mobile device and determines the option by referring to user's state information delivered from the mobile device. The user's state information includes emotional state information and physical state information.

### CROSS-REFERENCE TO RELATED APPLICATION

This application claims priority under 35 U.S.C §119(a) to Korean Patent Application No. 10-2014-0083964, filed on Jul. 4, 2014, the entire content of which is incorporated herein by reference.

### BACKGROUND

This invention is about a control station which controls a plurality of devices based on user command received by wire or wirelessly.

A general control station controls devices based on user command, which are preset to communicate with the control station. User command may be delivered on wire or wirelessly from a remote place, or received through a command input device attached on a control station. Or, user command may be given directly to a control station by voice recognition function equipped in the control station.

Devices which are controlled by a control station communicate with the control station by using a preset communication protocol. A user can set a device to communicate with a control station in advance of controlling the device. The device may be connected with the control station on wire or wirelessly.

A general control station controls preset devices mainly by simple user commands like turning on or off. However, as devices are getting equipped with more various functions, some devices require additional commands in addition to basic on/off commands. Thus, in some cases, by traditional simple user commands, it is difficult to precisely control devices as a user wants. And, to exactly meet user's requests, devices should be controlled by taking account of user's emotional and physical state. However, a control station in the prior technology has a limit to control devices by taking account of user's state information.

A control station in this invention enables user to make an additional option required to execute a user command, in addition to simple on/off command, i.e., command to turn on or off a device. Especially, the control station may receive user's state information from a mobile device of a user for setting an additional option, and automatically control devices to make adjacent devices most suitable for the user by utilizing the addition option.

User's state information which a control station in this invention utilizes includes user's emotional state information and/or physical state information. Preferably, the control station utilizes the both together. By utilizing those information, the control station may smartly control devices in order to provide an environment which can meet even potential needs of the user.

### SUMMARY

An embodiment in this invention is about a control station and a control system including thereof, which is configured to control user's adjacent devices based on user's emotional and/or physical state information obtained from the mobile device itself or a bio-sensor associated with the mobile device. The control system comprises a bio-sensor which is connected with a mobile device wirelessly and transmits user's physical state information to the mobile device, the mobile device which is configured to store voice and text information inputted by the user and also information delivered from the bio-sensor, and to determine and store user's emotional and/or physical state information based on the stored information, and a control station which is connected with the mobile device on wire or wirelessly and configured to control adjacent devices based on user's emotional and/or physical state information delivered from the mobile device and also based on user command inputted for controlling one of the adjacent devices.

Another embodiment in this invention is about a control station and a control system including thereof, which is configured to control user's adjacent devices based on user's emotional and/or physical state information obtained from the mobile device itself or a bio-sensor installed independently from the mobile device. The control system comprises a mobile device which is configured to determine and store user's emotional state information based on voice and text information input by the user, a control station which is connected with the mobile device on wire or wirelessly and also with a bio-signal detector having a bio-sensor, and is configured to control adjacent devices based on user command inputted for controlling one of the devices and also by referring to user's emotional state information delivered from the mobile device and/or physical state information obtained from the bio-signal detector.

Another control system according to the invention comprises a mobile device configured to determine and store user's emotional state information from voice and text information inputted by user, a bio-signal detector which is connected with at least one of adjacent devices wirelessly and delivers user's physical state information to the at least one of adjacent devices, and a control station which is connected with the mobile device and controls adjacent devices based on user commands for controlling the adjacent devices, by referring to the user's emotional state information delivered from the mobile device and/or the user's physical state information delivered from the at least one of adjacent devices.

A control station may have a reference table for determine at least one option for performing user command based on user's emotional state information and/or user's physical state information. Adjacent devices controlled by a control station may have each own reference table, which can be transmitted to and stored in a memory of the control station.

A control station may set a default option for each of adjacent devices, wherein the default option can be utilized in case that there is no user state information.

A control station may set frequency of communication with a mobile device, such as periodic communication or communication whenever requested. When communicating by request, in case that the information received from a mobile device was generated before a given time period from the time point when the communication is requested, the control station may make i) the mobile device generate and deliver new information at a current time point, ii) the mobile device generate and deliver predicted value at a current time point from old information stored in the mobile device, or iii) itself generate predicted value at a current time point from old information stored in itself.

In this invention, a control station and a mobile device may communicate each other in cased that the mobile device is within a given distance from the control station, manually connected on wire by user, or is positioned in a particular location on the control station.

A control station may receive user command to control adjacent devices in voice, or through buttons or a touch screen positioned on an outer surface of the control station.

A control station may communicate directly with a bio-signal detector. In this case, the control station may have a bio-signal receiver which receives bio-signals transmitted from the bio-signal detector, and a bio-signal processor which derives quantitative bio-signal values from the bio-signals received.

A control station may communicate with a mobile device and adjacent devices wirelessly. In this case, in order to minimize communication interference, protocols between the control station and other devices, including the mobile device, may be set differently each other.

Meanwhile, a mobile device which communicates with a control station may have a component to determine user's emotional state. Therefore, the mobile device may have an emotional word extractor which extracts emotional words from voice and text information inputted by a user, an emotional elements analyzer which expresses emotional elements in numbers by assigning values to extracted emotional words and summing up assigned values in each of emotional elements for a give time period, and an emotional state extractor which derives emotional state information based on emotional elements of which total summed values for the given time are over a certain threshold value.

A mobile device may periodically save user's emotional and/or physical state information, and transmit to the control station the most recent information when communication becomes available, or all the information within a given time period from when communication becomes available.

A mobile device may have user identifier information to distinguish between users, and send the user identifier information to the control station when communication becomes available. The control station may save information which belongs to a particular user for controlling devices and use the information for setting default options for that particular user.

A control system and control station in this invention may be applied for controlling electronic devices at home, a variety of devices in factory, and user convenience devices in a vehicle.

This invention enables to efficiently control adjacent devices having various options. This invention also enables to control adjacent devices in order to provide a user with an environment condition best suitable for the user by taking into account user's current emotional and/or physical state.

### BRIEF DESCRIPTION OF THE DRAWINGS

FIG. 1 shows a control system utilizing a mobile device according to an embodiment of the invention.

FIG. 2 shows an internal configuration of a mobile device and a bio-signal detector according to the first embodiment of the invention.

FIG. 3 shows an internal configuration of an emotional state determining module according to the first embodiment of the invention.

FIG. 4 shows an internal configuration of a control station according to the first embodiment of the invention.

FIG. 5 shows a control system coupled with a mobile device according to the second embodiment of the invention.

FIG. 6 shows an internal configuration of an emotional state determining module according to the second embodiment of the invention.

FIG. 7 shows a control system coupled with a mobile device according to the third embodiment of the invention.

FIG. 8 shows an operation flow of a control station according to the invention.

### DETAILED DESCRIPTION

Detailed explanation on desirable embodiments of the invention is made by referring to attached figures. In explaining the invention, in case that detailed explanation on relevant well-known function or structure could possibly make confusion in understanding the invention, such detailed explanation would be skipped. In this description, when an element transfers, delivers, sends or transmits signal or information to another element, it means that the transfer, delivery, sending or transmission can be made directly from one element to another element, or via at least one third element.

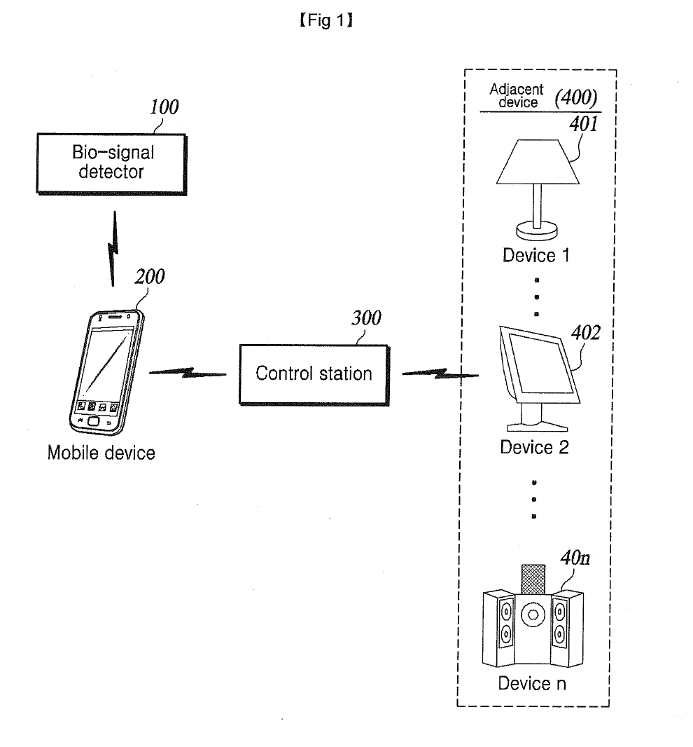

A control system coupled with a mobile device according to the first embodiment is described by referring to the FIG. 1 to FIG. 4. The first embodiment includes a bio-signal detector (100) which detects user's bio-signals; a mobile device (200) which determines and stores physical state of the user based on signals from the bio-signal detector and emotional state of the user based on information inputted from a text or voice input module; and a control station (300) which determines more correct user's state, based on user's state information previously received from the mobile device and text and/or voice information inputted recently, and controls adjacent devices.

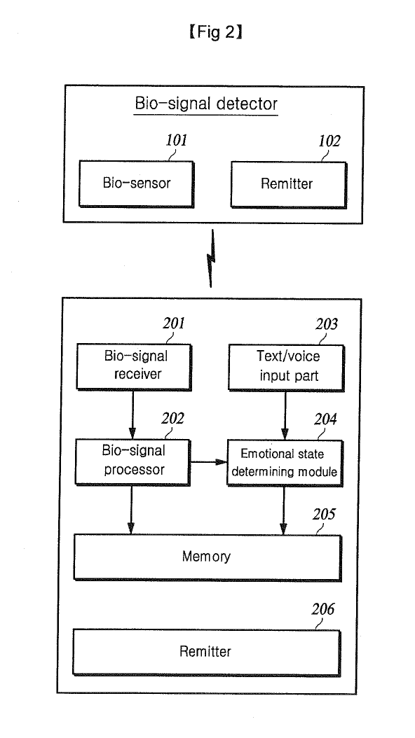

In FIG. 2, a bio-signal detector detects user's bio-signals using a bio-sensor. The bio-signals include body temperature, heart pulse and brainwave. Body temperature can be measured by gripping the bio-signal detector which has a bio-signal sensor on the surface of it. Body temperature sensor may output different levels of temperature signals in current or voltage according to different temperature. As examples of such temperature sensors, there are temperature IC made of semiconductor, thermistor made of ceramic, platinum resistance sensor, thermopile, and IR sensor. Heart pulse may be measured by contact sensor (2 points or 4 points). For example, heart pulse may be measured by connecting electric components with conductive polymer adhesives and amplifying electric signals generated. For measuring brainwaves, compact brainwave measurement devices which have electrodes may be used. Such devices can be made in a form of earphone or headset. Bio-signals may be transmitted to a mobile device (200) via a transmitter (102).

The mobile device (200) may activate the bio-signal detector. In case that the mobile device (200) activates the bio-signal detector, the bio-signal detector detects bio-signals and transmits the detected bio-signals periodically to the mobile device.

As shown in FIG. 2, big-signals transmitted to the mobile device are used for deriving bio-signal values by a bio-signal processor (202), and then the bio-signal values are used for determining user's physical state. In case that bio-signal is body temperature, whether body temperature is over a preset value or not is determined. In case of heart pulse, the bio-signal processor (202) may determine how much the user exercised based on current heart pulses in comparison with heart pulses in a normal state. In case of brainwaves, like as delta wave (0˜4 Hz), theta wave (4˜8 Hz), alpha wave (8˜13 Hz), beta wave (13˜30 Hz), gamma wave (30˜50 Hz), brainwaves are obtained in various frequency ranges, and its kinds are categorized based on predetermined frequency. Further, based on relative intensity between such categorized brainwaves and position in brain where brainwaves are generated, criterions for classifying kinds of emotion may be set, and based on such criterions, user's current emotional state may be determined.

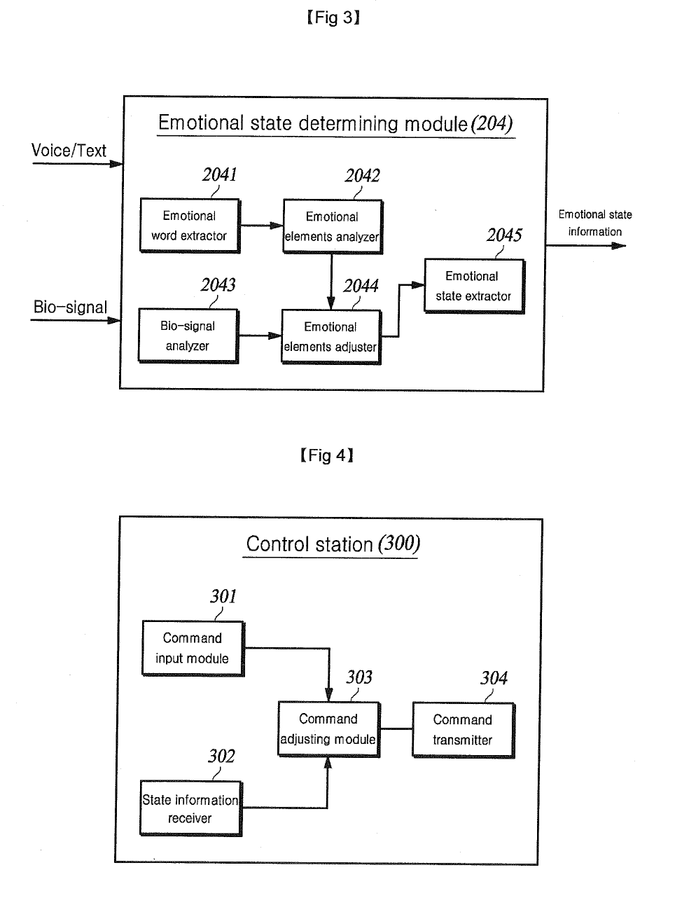

As shown in FIG. 3, user inputs text and voice information into the mobile device substantially continuously. An emotional state determining module (204) in the mobile device determines user's emotional state based on text and voice information inputted. An emotional word extractor (2041) extracts emotional words from text and voice information. Then, an emotional elements analyzer (2042) assigns values to respective extracted emotional words and add up assigned values for words belonging to each of same emotional elements (for example, happiness, sadness, anger, anxiety, surprise, boredom and etc.). By doing this, degree of each emotional element may be quantified. For example, in case that emotional words belonging to the emotional element “happiness” (such as “excited”, “joyful”, “good”.) are extracted, a value is assigned to each word. A higher value is given to a word which can express happiness more clearly than other word. By totalizing values for words in the emotional element “happiness” for a predetermined period of time, degree of the emotional element “happiness” is quantified. This quantification method is applied to each of emotional elements, for quantifying all emotional elements.

In order to determine emotional state more correctly, the emotional state determining module (204) may utilize bio-signals additionally. In FIG. 3, a bio-signal analyzer (2043) may set a threshold value with respect to bio-signal values received from the bio-signal processor (202) in order to determine a particular emotional element, compares received bio-signal values with the threshold value, and express numerically how much of quantitative value the particular emotional element has. An emotional elements adjuster (2044) evaluates each emotional element more correctly by reflecting values obtained from the bio-signal analyzer on corresponding values of emotional elements obtained from the emotional elements analyzer. In the next, an emotional state extractor (2045) compares values for respective emotional elements with a threshold value, disregards one or more emotional elements of which value is lower than the threshold value, and finally determines user's emotional state based on emotional elements of which value is higher than the threshold value. For example, in case that the values of “happiness”, “sadness”, “anxiety” and “surprise” are 50, 10, 20, 40 respectively, and the threshold value is 30, the emotional elements of “sadness” and anxiety” are disregarded, and “happiness” and “surprise” are only taken into account for determining final user's emotional state. User's emotional state obtained from the emotional state determining module is stored in a memory (205) of the mobile device with user's physical state information.

Taking into account change of user's emotional state according to time, it is important to determine user's emotional state at a current time point more correctly. For this, history information on emotional state may be utilized additionally. Specifically, the emotional state determining module (204) periodically repeats routine for determining user's emotional state, and stores user's emotional state. Therefore, when determining current user's emotional state, the current emotional state may be predicted based on stored emotional state information. Prediction method may put more weight on information recently stored than on old information, and may take the average of weighted emotional state information, with respect to information stored for a predetermined period of time.

As shown in FIG. 4, the internal configuration of the control station (300) includes a command input module (301), a state information receiver (302), a command adjusting module (303), and a command transmitter (304). The command input module (301) is configured for a user to input a command to control an adjacent device, and the command may be inputted by manually typing text command, speaking command via a microphone of the control station, or by other various kinds of input method. For example, in case that a user wants to control a particular lamp near the control station, the user may speak “turn on the lamp” to deliver a command to the control station.

A state information receiver (302) receives emotional state information and/or physical state information transmitted from the mobile device. Information exchange between the mobile device and the control station may be performed when both devices are within a predetermined distance, the mobile device is within a predetermined space where the control station is located, the mobile device is put on a particular location of the control station, or the mobile device is connected with the control station on wire. A command adjusting module (303) determines additional options by using received physical state information and/or emotional state information for executing user command inputted via the command input part. For example, in case that a user inputs command to turn on a lamp, the control station determines how much of intensity of illumination would be set along with turning the lamp, by referring to the received emotional state information and/or physical state information.

The command transmitter (304) transmits command received from the command adjusting module and additional options related with the command, toward a corresponding adjacent device. The control station may register a plurality of adjacent devices (401, 402, . . . , 40n) which are remotely controllable on wire or wirelessly. In case that adjacent devices were already connected with the mobile device, at the time when the mobile device becomes connected to the control station, information on adjacent devices may be automatically delivered to the control station, and those adjacent devices may be also automatically registered to the control station as controllable.

An operation flow of the first embodiment in the invention is as follows. A bio-signal detector detects user's bio-signal by using a bio-sensor, and transmits detected bio-signal to a mobile device through a transmitter. The bio-signal received by a receiver of the mobile device is transformed into quantitative bio-signal values through a bio-signal processing part.

Meanwhile, user may input text information via SMS and voice information during call. Text and voice information that user has inputted includes information with which user's emotional state can be predicted. An emotional state determining module (204) extracts emotional words from inputted text or voice information, and analyzes emotional elements based on kinds, intensity and frequency of emotional words. Quantified emotional elements are adjusted at an emotional elements adjuster (2044) by further reflecting values obtained from a bio-signal analyzer (2043), and emotional state information is finally extracted. Physical state information (including bio-signal values) and emotional state information are stored in a memory (205) of a mobile device, and transmitted to a control station when communication between the mobile device and the control station is available. There could be time difference between when physical state information and/or emotional state information are stored and when communication between the mobile device and the control is available. In this case, in order to obtain more correct current physical state information and emotional state information, the mobile device may obtain and resend such information when communication becomes available, or may send to the control station estimated information at a current time based on previously stored information. In case that the control station determines that transmitted information was generated a preset time before, the control station may request the mobile device to obtain and resend updated information, or utilize estimated information at a current time based on previously stored information.

User may set a command to at least one of control adjacent devices connected with the control station, within a distance adjacent to the control station or at a position allowing to communicate with the control station. After receiving a command, the control station may determine an option required to execute the command by referring to physical state information and emotional state information received from the mobile device. Determining the option may be carried out by referring to a reference table predetermined based on physical state information and emotional state information. If a command including required option is completed, the command may be sent to a predetermined device for controlling the predetermined device.

In some cases, the control station may have to determine an option required to execute a command without any information delivered from the mobile device. In this case, the control station may be set to select a default option or a predetermined option which was set by manufacturer or user depending on adjacent devices.

In this invention, the control station may communicate with mobile device and adjacent devices wirelessly. In order to reduce wireless interference, communication protocols may be set differently between devices. For example, it is desirable that communication protocol between a mobile device and a control station is WLAN, and that between a control station and adjacent devices is ZigBee.

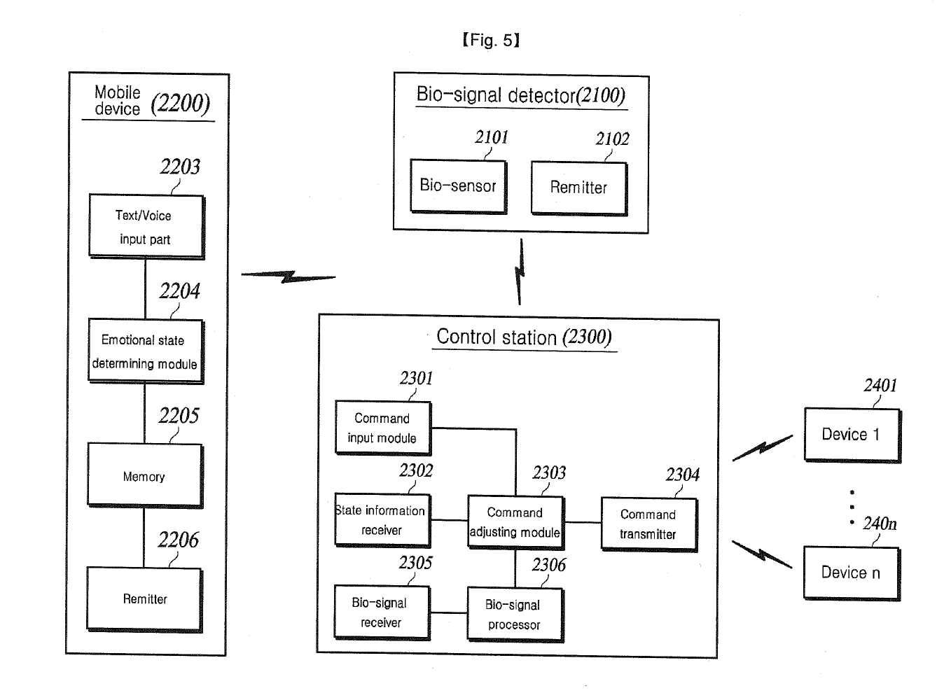

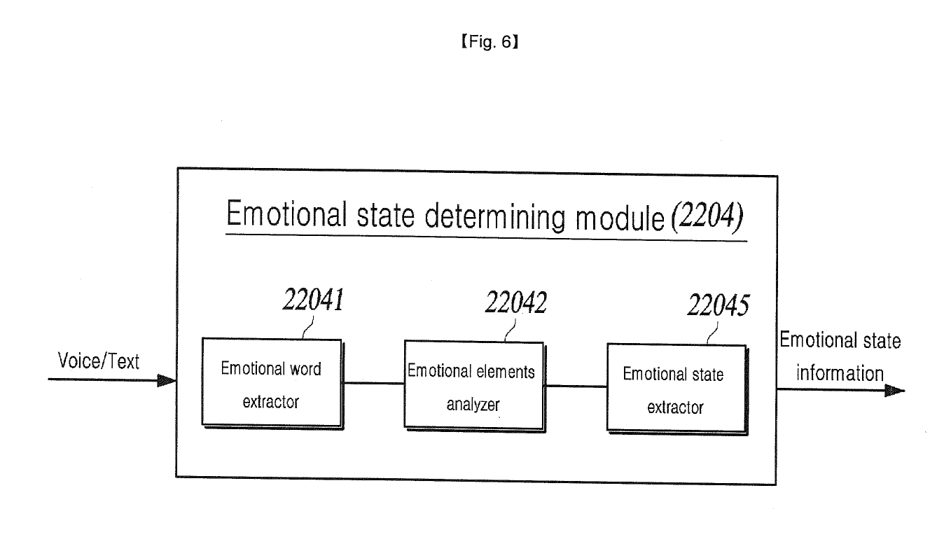

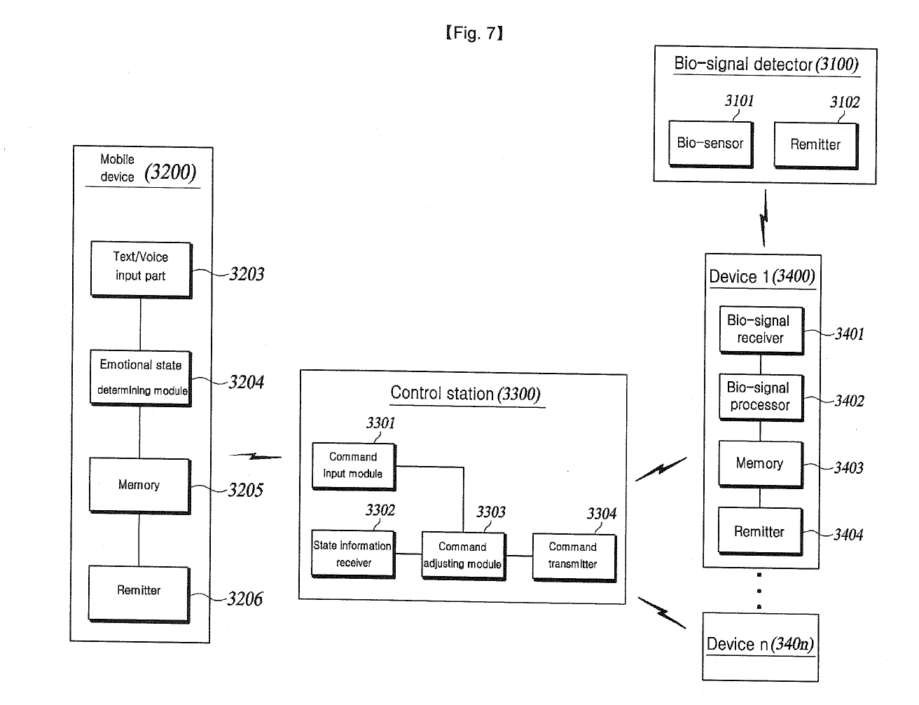

A user state recognition and control system according to the second embodiment of this invention is described based on FIGS. 5 and 6. As FIG. 5, a biggest difference between the first embodiment and the second embodiment is that a bio-signal detector (2100) is located in a control station. In this case, the mobile device (2200) may not have a separate bio-signal detector operating in connection with the mobile device, such that the mobile device does not have function related to bio-signal. A emotional state determining module (2204) inside the mobile device extracts emotional words from inputted text and/or voice information, analyzes emotional elements based on kinds, intensity and frequency of emotional words, and finally derives emotional state information. According to FIG. 6, the emotional state determining module (2204) comprises an emotional word extractor (22041) which extracts emotional words from imputed text and/or voice information, an emotional elements analyzer (22042) which analyzes emotional elements based on kinds, intensity, and frequency of emotional words, and an emotional state extractor (22045) which finally derives user's emotional state by comparing values for respective emotional elements with threshold values, disregarding one or more emotional elements of which value is lower than a threshold value, and referring to emotional elements of which value is equal to or higher than a threshold value. The emotional state information derived from the emotional state deriving part is stored in a memory (2205) and transferred to the control station when communication between the mobile device and the control station becomes available.

In the second embodiment, differently from the first embodiment, the emotional state determining module does not include an emotional element adjuster which adjusts values for emotional elements with measured bio-signal values. (FIG. 7)

Meanwhile, the bio-signal detector (2100) is connected with the control station (2300) on wire or wirelessly. In the same manner with the first embodiment, the bio-signal detector detects user's bio-signal by using a bio-sensor (2101). Bio-signals are transmitted by a remitter (2102) to the control station. The control station (2300) may set whether to activate the bio-signal detector. In case that the control station activates the bio-signal detector, the bio-signal detector periodically measures user's bio-signals and sends them to the control station. The control station has a bio-signal receiver (2305) and a bio-signal processor (2306) inside. The bio-signal receiver receives bio-signals sent from the bio-signal detector, and the bio-signal processor determines user's physical state based on quantified bio-signal values.

In the second embodiment, user may set commands to control adjacent devices connected with the control device through a command input module (2301). The command input module may receive user's commands in voice or by an inputting means disposed on an outer surface of the control station. When a command is given by user, in order to determine an option required to execute the command, a command adjusting module (2303) may refer to user's emotional state information delivered from the mobile device and/or user's physical state information (including bio-signal values) obtained from the bio-signal detector. After an option required to execute the command is determined, the command is sent to a corresponding adjacent device via a command transmitter (2304).

An operating flow for the second embodiment is like followings. The mobile devices stores inputted text and/or voice information for a preset time. The emotional state determining module (2204) extracts emotional words from the stored text and/or voice information, and quantifies respective emotional elements in a certain range of values based on kinds, intensity, and frequency of respective emotional elements. After disregarding emotional elements of which quantified values are lower than a threshold value, emotional state information may be derived. The emotional state information may be stored in the memory (2205), and then transferred to the control station when communication between the mobile and the control station becomes available.

Independently from the mobile device, the bio-signal detector (2100) detects user's bio-signals and transfers them to the control station. A bio-signal receiver and a bio-signal processor perform receiving bio-signals and quantifying them in a certain range of values.

User gives a command to control adjacent device through the control station. In case that an option is required to execute the command, user's emotional state information transmitted from the mobile device and user's physical state information (including bio-signal values) obtained from the bio-signal detector are utilized. Manufacturer may set a reference table where an option changes according to the user's emotional state information and physical state information, and the control station may determine an option by referring to the reference table. The command adjusting module (2303) determines an option required to execute a command, and the command remitter (2304) sends the command with the option to an corresponding adjacent device, after giving a command by user and setting a relevant option by the control system is completed.

FIG. 7 shows the third embodiment of this invention. A main difference of the third embodiment compared with other embodiments is that a bio-signal detector (3100) communicates with a particular adjacent device (3401), and bio-signals are transmitted to a control station through the particular adjacent device. The bio-signal detector is connected with one of multiple adjacent devices on wire or wirelessly. The bio-signal detector detects user's bio-signals by utilizing a bio-sensor (3101). Kinds of user's bio-signals include body temperature, heart pulses and brain waves. User's bio-signals are transmitted to the particular adjacent device through a remitter (3102). The particular adjacent device may be able to set whether to activate the connected bio-signal detector. In case that the particular adjacent device activates the bio-signal detector, the bio-signal detector periodically detects user's bio-signals and sends them to the particular adjacent device. Bio-signals sent to the particular adjacent device are processed by a bio-signal processing part (3402) to derive bio-signal values, and user's physical state is determined based on the bio-signal values. User's physical state information is stored in a memory (3403) of the particular adjacent device, and transmitted to the control station via a remitter (3404) of the particular adjacent device, when communication between the particular adjacent device and the control station becomes available.

Similarly as other embodiments, user's emotional state information may be transmitted from a mobile device to the control station, and stored in a memory (not shown) of the control station. In the third embodiment, physical state information is transferred to the control station from the particular adjacent device. Therefore, user's physical state information obtained from one adjacent device is utilized by the control station in controlling other adjacent devices.

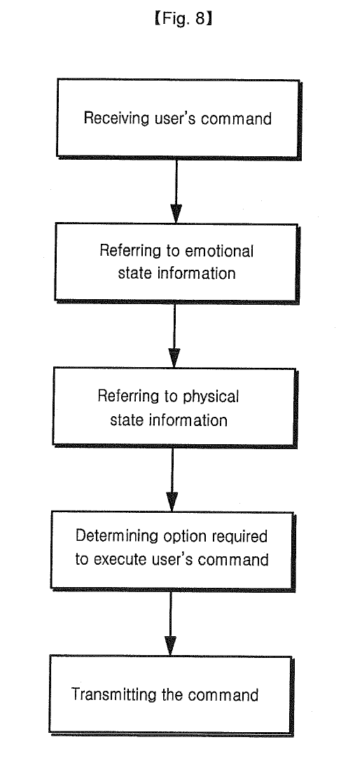

FIG. 8 shows operation flow of a control station in this invention. When user gives a command in voice or via an inputting means disposed on an outer surface of the control station, a command adjusting module refers to user's emotional state information and physical state information stored in the memory of the control station. In the first embodiment, such emotional state information and physical state information are received from a mobile device and stored in the memory of the control station. In the second embodiment, user's emotional state information is received from a mobile device, but user's physical information is generated and stored in the control station based on bio-signals received from a bio-signal detector directly connected with the control station. Further, in the third embodiment, user's emotional state information is received from a mobile device to a control station, but user's physical state information is transmitted from an adjacent device particularly connected with the control station. The command adjusting module may determine an option required to execute a command by referring to a preset reference based on the user's emotional and/or physical state information. The command with the determined option is transmitted to a targeted adjacent device via a command transmitter.

A control station in this invention may be applied to various situations and environments. In case that the control station is located in a room of a house, the control station may control various electric devices at home. Further, in case that the control station is located in a vehicle, the control state may control internal lamps, sound devices and safety devices in the vehicle.

1. A control station comprising:
a command input module to receive a user command from a user for controlling a device;
a first receiver to receive user's emotional state information from a mobile device of the user, wherein the mobile device extracts the user's emotional state information from voice or text information inputted by the user;
a second receiver to receive user's physical state information from a bio-signal detector;
a command adjusting module to determine at least one option for performing the user command based on the user's emotional state information and user's physical state information; and,
a command transmitter to send the user command with the at least one option toward the device.

2. The control station according to claim 1, wherein the command input module is located inside the control station and has voice recognition function.

3. The control station according to claim 1, wherein the command input module is exposed outside the control station and includes a touch-type input part.

4. The control station according to claim 1, wherein the timing when the control station receives state information from the mobile device is after the mobile device is put on a specified docketing place.

5. The control station according to claim 1, wherein the user's physical state information is delivered to the control station via the mobile device.

6. The control station according to claim 1 further comprises a memory including a reference table which is referred in order to determine the at least one option based on the user's emotional state information and user's physical state information.

7. The control station according to claim 6, wherein the reference table is generated and transmitted from an outer device and stored in the memory.

8. The control station according to claim 6, wherein the memory stores at least two different reference tables and each reference table depends on its corresponding device.

9. The control station according to claim 6, wherein in case that the user's emotional state information and/or the user's physical state information cannot be used, the option is set as a default value.

10. The control station according to claim 9, wherein the default value is different depending on devices controlled by the user.

11. The control station according to claim 1, wherein in case that user state information received from the mobile device and/or the bio-signal detector has been generated before a predetermined time period, the control station requests the mobile device and/or the bio-signal detector to generate user state information and send them again.

12. A control system comprising :
a mobile device to extract user's emotional state information from voice or text information inputted therein;
a bio-signal detector to include a bio-sensor which detects user's physical state information and to transmit the user's physical state information; and
a control station configured to be connected with the mobile device and the big-signal detector, and to control a device based on the user's emotional state information received from the mobile device, the user's physical state information received from the bio-signal detector and a user command inputted by a user.

13. The control system according to claim 12, wherein the mobile device comprises a emotional word extractor which extracts emotional words from voice or text information inputted by a user, an emotion elements analyzer which assigns values to the extracted emotional words and quantify emotion elements by summing assigned values for the emotional words, and an emotional state extractor which determines user's emotional state by comparing numbers for each emotion element with a predetermined critical value.

14. The control system according to claim 12, wherein the mobile device stores user's state information into its internal memory and automatically transmits the information to the control station at the time when communication between the mobile device and the control station becomes available.

15. The control system according to claim 12, wherein the mobile device stores user's state information into its internal memory and automatically transmits the information to the control station at the time when the mobile device is located in a specified position.

16. The control system according to claim 12, wherein the information delivered from the mobile device was generated within a predetermined time period before the communication between the mobile device and the control station becomes available.

17. The control system according to claim 12, wherein the control system receives a user identifier when communication between the mobile device and the control station becomes available, and sets at least one option for performing the user command based on the user identifier.

18. A method for operating an control station comprising:
receiving a user command inputted by a user for controlling a device;
receiving user's emotional state information from a mobile device of the user, wherein the mobile device extracts the user's emotional state information from voice or text information inputted by the user;
receiving user's physical state information from a big-signal detector attached to the user;
determining at least one option for performing the user command based on the user's emotional state information and the user's physical state information; and
transmitting the user command and the at least one option to the device.

19. The method according to claim 18, wherein the step of receiving user's emotional state information is performed i) after the mobile device is located within an area where communication between the mobile device and the control station is available, ii) after the mobile device is put on a specified position near the control station, or iii) after the mobile device is connected to the control station by wire.

20. The method according to claim 18 further comprises requesting updated information from the mobile device or the bio-signal detector, in case that the user state information delivered from the mobile device or the bio-signal detector was generated prior to a preset time.
